(19) United States
(12) Patent Application Publication
(10) Pub. No.: US 2020/0330803 A1
(43) Pub. Date: Oct. 22, 2020

(54) PERIMETER FIRE BARRIER SYSTEM

(71) Applicant: Specified Technologies Inc., Somerville, NJ (US)

(72) Inventors: James P. Stahl, JR., Princeton Junction, NJ (US); Paul Gandolfo, Doylestown, PA (US); Julio Lopes, Dunellen, NJ (US)

(21) Appl. No.: 16/385,594

(22) Filed: Apr. 16, 2019

(51) Int. Cl. A62C 2/06; E04B 2/90

(52) U.S. Cl. CPC A62C 2/06; E04B 2/90

(57) ABSTRACT

A curtain wall assembly including a curtain wall and a slab attached to the curtain wall with a gap therebetween. A fire rated bumper assembly is positioned in and seals the gap between the curtain wall and the slab. The fire rated bumper assembly includes a back plate configured for connection to either the curtain wall or the slab. A bumper is attached to the back plate and has an elongated body manufactured from a fire-retardant elastomer which encloses a high temperature insulation material.

### FIELD OF THE INVENTION

The invention generally relates to apparatus for providing a firestop within a construction opening and, more particularly, to a firestopping apparatus configured to provide firestopping along a slab edge.

### BACKGROUND OF THE INVENTION

Modern, multiple story buildings may be formed with an external wall structure that is secured to a floor slab. The external wall structure, or curtainwall, is secured to the slab, which is made of concrete, at a distance spaced away from the slab. By creating a gap between the slab and the curtainwall, proper alignment of the curtainwall is ensured. For example, in the event that the slab for a particular floor is not entirely straight or the slabs of adjacent floors are not properly aligned, the size of the gap between the curtainwall and a slab may be adjusted at various points along the slab to align the curtainwall so that it is substantially straight along the entire length and/or height of the building.

While the gap created between the curtainwall and the slabs of a building may be necessary to allow for proper alignment of the curtainwall, in the event of a fire, smoke, hot gasses, and/or flames may pass from one floor to another through the gap between the curtainwall and the slabs. In order to prevent smoke, hot gasses, and/or fire from passing freely through this gap, safing insulation may be positioned between the slabs and spandrels of the curtainwall. Typically the void area is sealed with mineral wool insulation and firestop sealants and sprays. This is field-installed by the contractors which are typically a different trade than the wall panel installers. Installing of such insulation is labor intensive and may cause delays do to weather or coordination of trades.

### SUMMARY OF THE INVENTION

In at least one embodiment, the present disclosure provides a fire rated bumper assembly including a back plate configured for connection relative to a curtain wall and slab spaced therefrom. A bumper is attached to the back plate and has an elongated body manufactured from a fire-retardant elastomer and which encloses a high temperature insulation material.

In at least one embodiment, the present disclosure provides a curtain wall assembly including a curtain wall and a slab attached to the curtain wall with a gap therebetween. A fire rated bumper assembly is positioned in and seals the gap between the curtain wall and the slab. The fire rated bumper assembly includes a back plate configured for connection to either the curtain wall or the slab. A bumper is attached to the back plate and has an elongated body manufactured from a fire-retardant elastomer which encloses a high temperature insulation material.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a perspective of a curtain wall with a fire rated bumper system in accordance with the disclosure positioned in the gap between the wall and the slab and secured to the curtain wall.

FIG. 2 is a side elevation view of the fire rated bumper system positioned in the curtain wall assembly.

FIG. 3 is a perspective view of an exemplary fire rated bumper assembly in accordance with an embodiment of the disclosure.

FIG. 4 is a perspective view of an exemplary insulation material of the bumper assembly of FIG. 3.

FIG. 5 is a cross-sectional view along the line 5-5 of FIG. 3.

FIG. 6 is a side elevation view similar to FIG. 2 illustrating adaptation of the bumper in response to a building shear movement.

FIG. 7 is a perspective of a curtain wall with a fire rated bumper system in accordance with the disclosure positioned in the gap between the wall and the slab and secured to the slab.

FIG. 8 is a perspective view illustrating a longitudinal joint with overlapping bumpers.

FIG. 9 is a perspective view illustrating a corner joint with abutting bumpers.

FIGS. 10 and 11 are a perspective view and a plan view, respectively, of a corner joint with mitered bumpers.

FIG. 12 is a perspective view of a slab with a fire rated bumper system in accordance with an embodiment of the invention attached thereto utilizing an embedded mounting strut.

FIG. 13 is a perspective view of an exemplary fire rated bumper assembly in accordance with an embodiment of the disclosure.

FIG. 14 is a perspective view similar to FIG. 12 illustrating the slab with an embedded mounting strut prior to installation of the fire rated bumper system.

FIG. 15 is a cross-sectional view along the line 15-15 in FIG. 14.

FIG. 16 is a perspective view similar to FIG. 14 illustrating a mounting bracket connected to the embedded mounting strut.

FIGS. 17 and 18 are perspective and side views, respectively, illustrating positioning of the fire rated bumper system relative to the mounting bracket.

FIGS. 19 and 20 are perspective and side views, respectively, illustrating the fire rated bumper system secured relative to the mounting bracket.

### DETAILED DESCRIPTION OF THE INVENTION

In the drawings, like numerals indicate like elements throughout. Certain terminology is used herein for convenience only and is not to be taken as a limitation on the present invention. The following describes preferred embodiments of the present invention. However, it should be understood, based on this disclosure, that the invention is not limited by the preferred embodiments described herein.

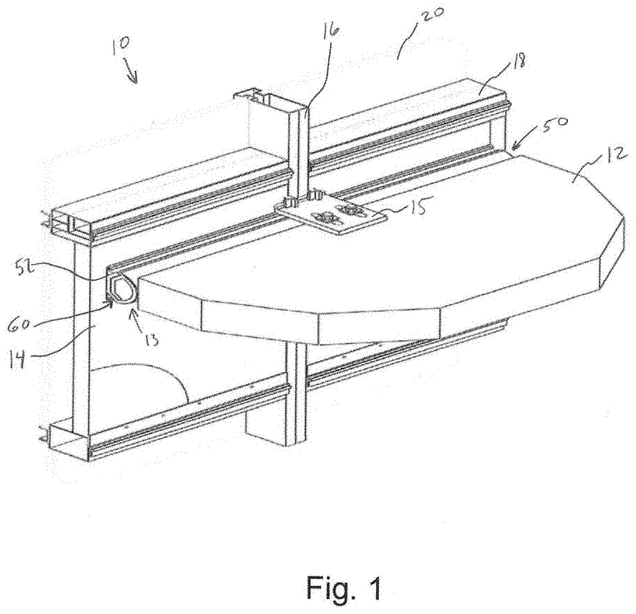

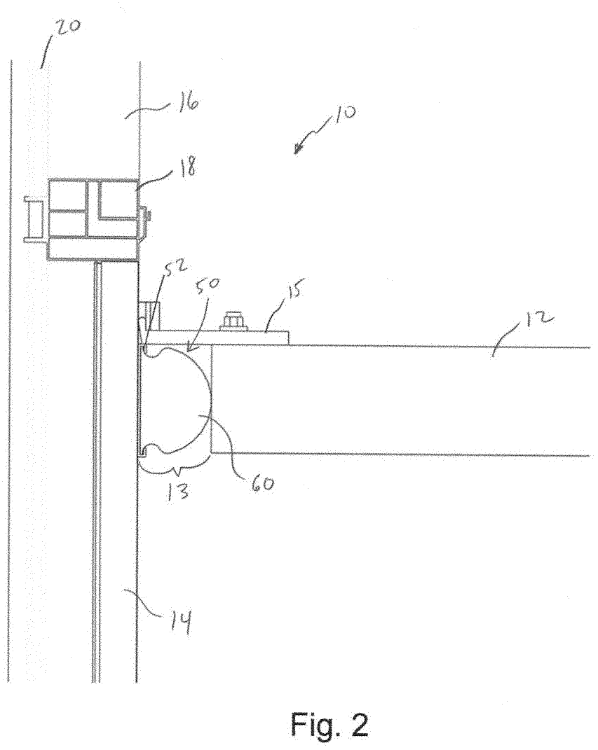

Referring to FIGS. 1 and 2, an exterior wall system is depicted generally at numeral 10. The wall system 10 is connected to a slab 12, which forms one of the floors of a multi-floor building. The wall system 10 includes spandrels 14 that, in one exemplary embodiment, define the exterior facade of the building. In one exemplary embodiment, the spandrels 14 cover the area between the sill of a first vision glass installation and the head of a second vision glass installation. The spandrel 14 is secured to mullions 16, which provide the vertical framework for wall system 10. Extending between the mullions 16 are transoms 18, which provide the horizontal framework for the wall system 10. Additionally, vision glass 20 may be positioned between portions of the mullions 16 and transoms 18. In this manner, the spandrels 14 and vision glass 20, provide the visible, aesthetic features of exterior wall system 10.

As discussed above, the wall system 10 is positioned at a distance spaced from the slab 12 and secured thereto via mounting brackets or anchors 15, for example, made from aluminum or steel. As a result, a gap 13 is created between the slab 12 and the wall system 10. In the event of a fire, smoke, hot gasses, and/or flames may travel through gap 13 between slab 12 and wall system 10 and pass between adjacent floors of the building. In order to prevent and/or delay the passage of smoke, hot gasses, and/or fire between adjacent floors of a building, a fire rated bumper assembly 50 is positioned in the gap 13.

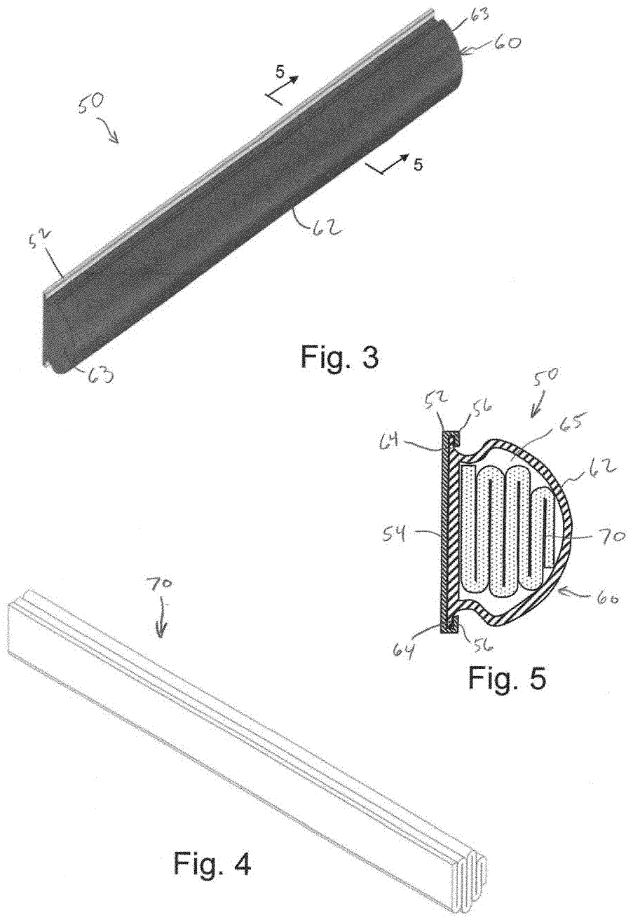

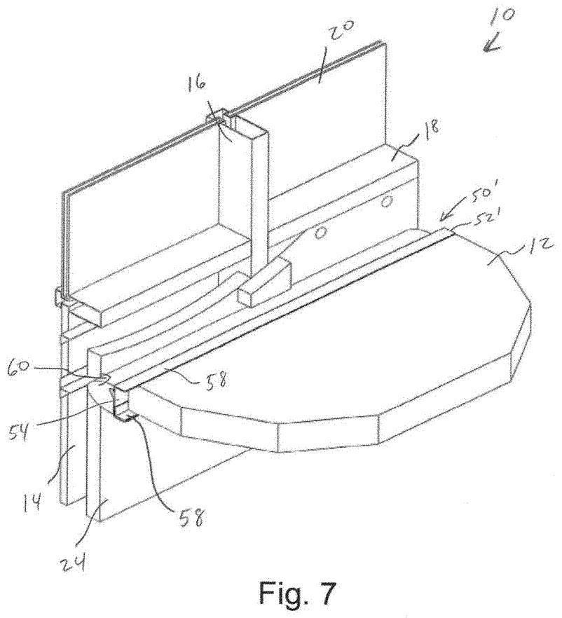

Referring to FIGS. 3-5, an exemplary fire rated bumper assembly 50 will be described. The bumper assembly 50 generally includes a mounting plate 52 and a fire rated bumper 60. In the illustrated embodiment, the mounting plate 52 includes a back surface 54 configured to be secured to the curtain wall 10. The mounting plate 52 includes opposed flanges 56 along the top and bottom edges which are configured to receive a portion of the bumper 60 to retain the bumper 60 in position. While the current embodiment illustrates the mounting plate 52 configured for connection to the curtain wall 10, the mounting plate can also be configured for mounting to the slab 12. With reference to FIG. 7, the fire rated bumper assembly 50′ includes a mounting plate 52′ which includes a pair of flanges 58 extending from the rear side of the surface 54 which define a channel into which the slab 12 is received. The mounting plate 52′ would then be secured to the slab 12 with adhesives, fasteners or the like. The two plates 52, 52′ provide the choice to affix the plate 52, 52′, and thereby the bumper assembly 50, 50′, either to the curtain wall 10 preferably in the factory at the time of manufacturer of the curtain wall 10 or to the edge of slab 12 for an in the field installation.

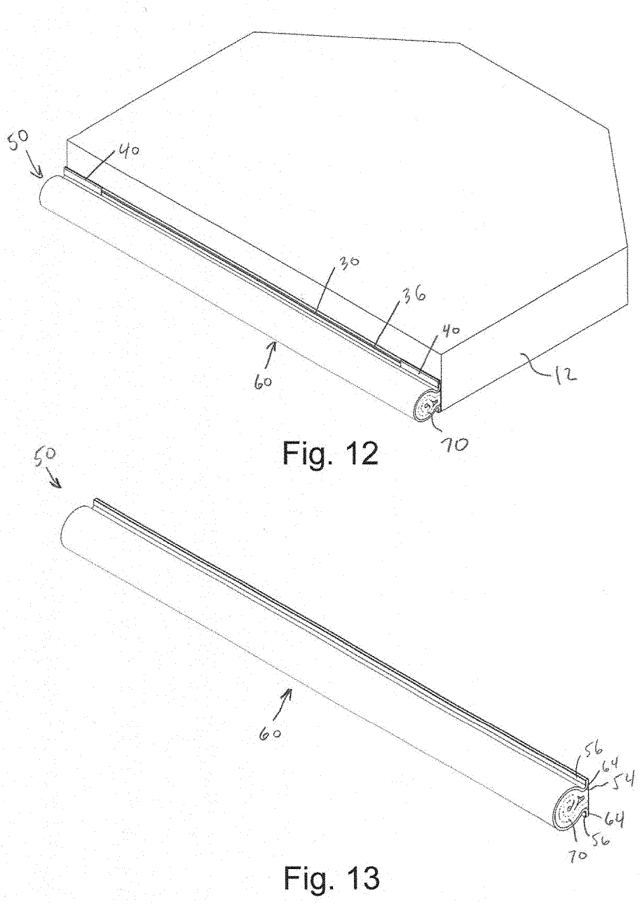

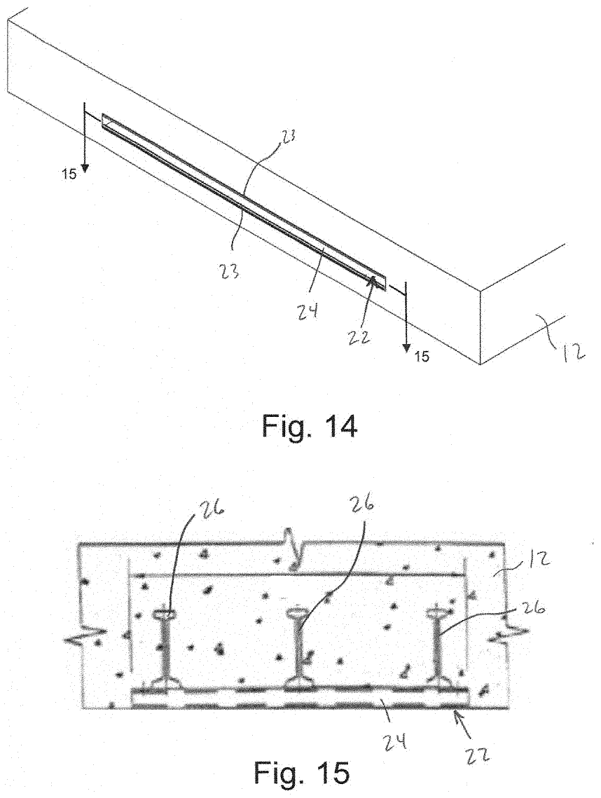

Referring to FIGS. 12-20, another method of attaching the fire rated bumper assembly to a slab 12 will be described. In the illustrated embodiment, the slab 12 is manufactured with an embedded mounting strut 22. Such mounting struts 22 are common within slab construction. The mounting strut 22 has a C-shaped channel 24 which is embedded within the slab 12. Posts 26 or the like may extend from the channel 24 to further secure the channel 24 within the slab 12. The upper and lower front edges of the channel 24 preferably include return flanges 23 such that expanding fasteners 33 or fasteners with heads may be secured relative to the channel 24, as is known in the field.

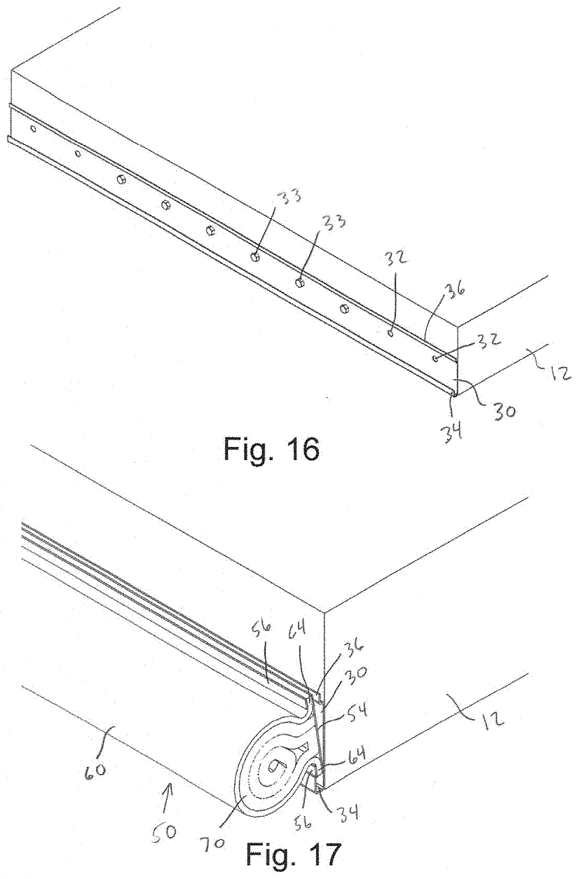

Referring to FIG. 16, a mounting bracket 30 is easily secured to the mounting strut 22 by passing fasteners 33 through holes 32 in the bracket 30. The fasteners 33 may have a portion configured to expand within the channel 24 upon tightening or may be configured to engage nuts or the like which are retained within the channel 24. The embedded mounting strut 22 allows the mounting bracket 30 to be easily and reliably secured to the slab 12.

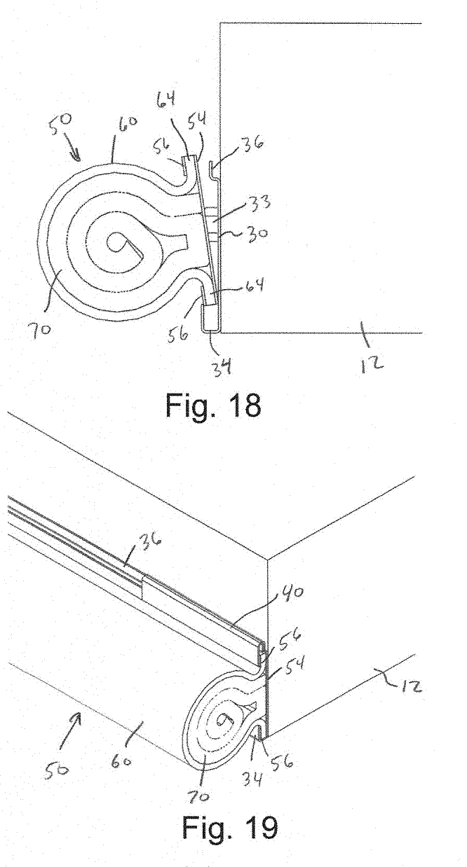

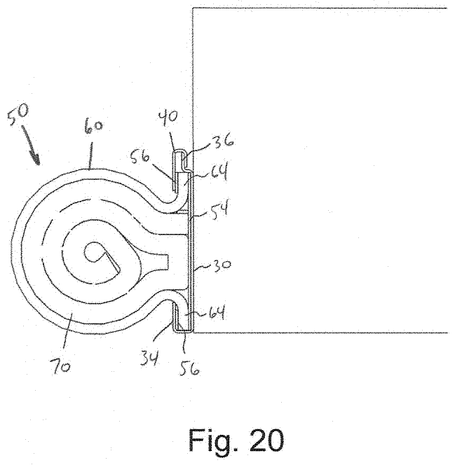

A lower edge of the mounting bracket 30 defines a U-shaped flange 34 configured to receive one of the flanges 56 of the fire rated bumper assembly 50 as illustrated in FIGS. 17 and 18. The upper edge of the mounting bracket 30 defines a linear flange 36 configured to receive securing clips 40, as will be described hereinafter. To mount the bumper assembly 50, the bumper assembly 50 is positioned at an angle relative to the mounting bracket 30 such that the first flange 56 is positioned within the U-shaped flange 34, as shown in FIGS. 17 and 18. The bumper assembly 50 is then rotated toward the mounting bracket 30 until the back surface 54 is adjacent the mounting bracket 30 and the other flange 56 is adjacent the linear flange 36 as shown in FIGS. 19 and 20. It is noted that the back surface 54 may have holes or slots (not shown) aligned with the fasteners 33 such that the back surface 54 may sit flush against the mounting bracket 30. Once the bumper assembly 50 is in position, U-shaped securing clips 40 are extended over the linear flange 36 and adjacent flange 56. As shown in FIG. 12, the clips may be positioned at various locations along the fire rated bumper assembly 50.

Referring again to FIGS. 3-5, the bumper 60 has an elongate body 62 extending between enclosed ends 63. The illustrated body 62 has a generally semi-circular cross-sectional shape, however, other configurations including, for example, square, rectangular, oval and the like, may be utilized. The opposite side of the elongate body 62 defines a pair of lateral lips 64 configured to be received in the flanges 56 of the mounting plate 52, 52′ to secure the bumper 60 to the plate 52, 52′. Other securing mechanisms, for example adhesives or fasteners, may be utilized to secure the bumper 60 to the plate 52, 52′. The elongate body 62 is manufactured from a fire-retardant elastomeric material, for example, a fire-retardant rubber polymer or similar material. While the illustrated body 62 is an extruded element, the disclosure is not limited to such. The elongate body may have various configurations, for example, a polyethylene or polypropylene bag or plastic sheet. A chamber 65 within the body 62 houses a high temperature insulation material 70, for example, a mineral fiber or ceramic fiber blanket. The insulation material 70 is preferably coiled or folded, such as accordion-style, to load up and ensure proper compression.

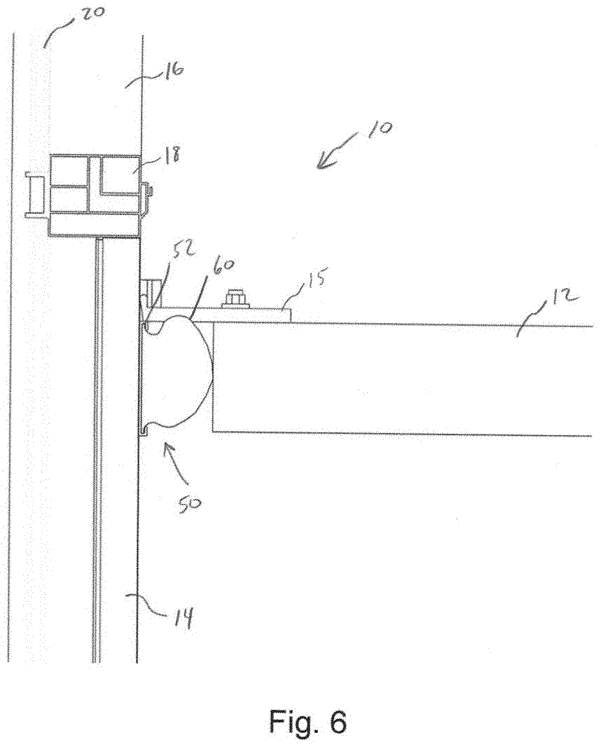

The weight of the unitized panels being hoisted into position loads up compression on the fire rated bumper 60, whether secured to the curtain wall 10 or the slab 12. This potentially allows for less support to be integrated into the back pan to prevent deflection due to thermal expansion under fire conditions. As the panel deflects, the overcompressed bumper 60 will re-expand to fill voids. The bumper system 50 also allows for movement, such as vertical shear due to torsional twist of the building, since the panel can independently move up and down without distressing the sealing system 50, as illustrated in FIG. 6.

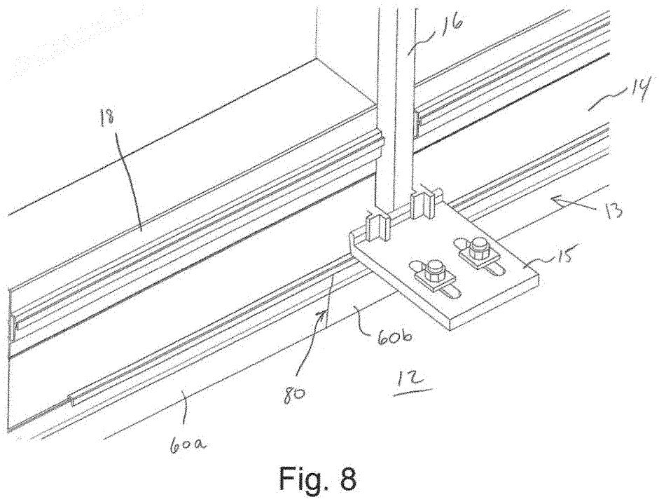

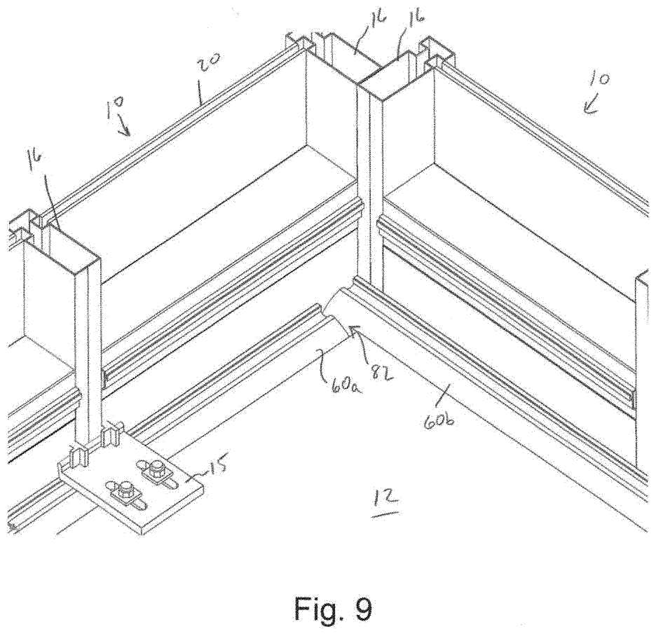

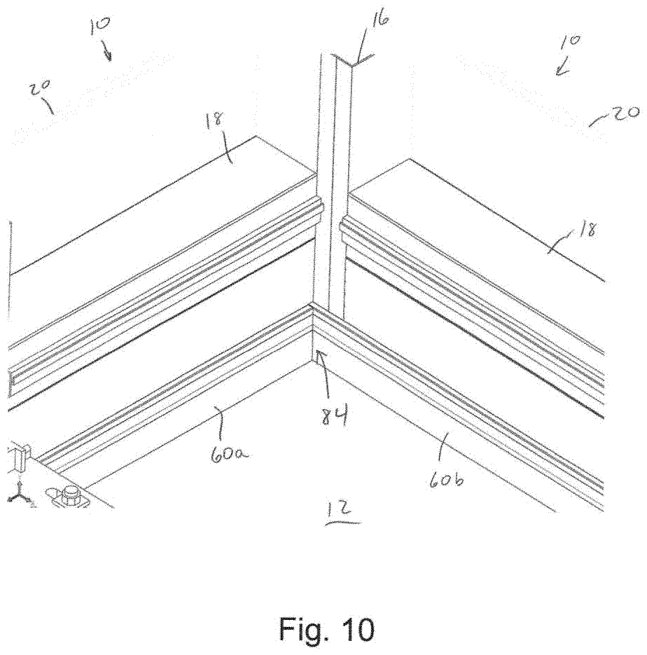

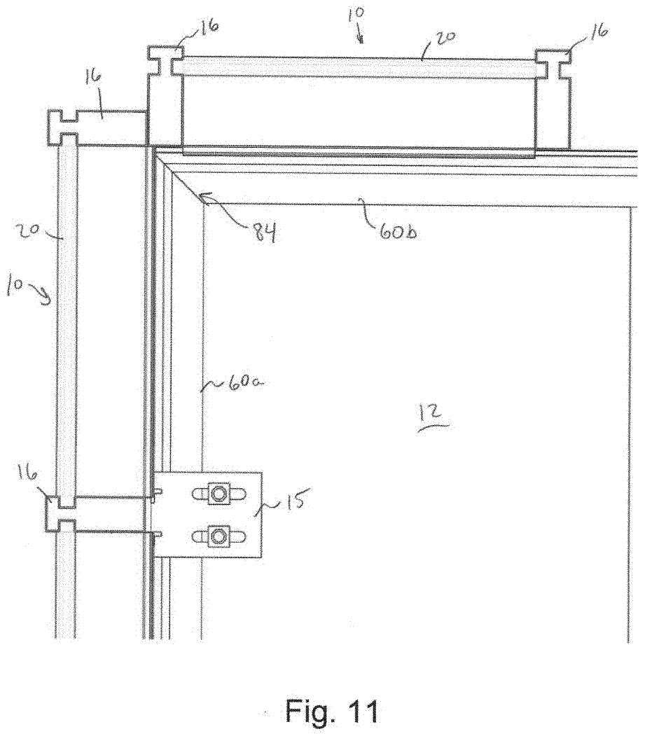

Referring to FIGS. 8-11, the bumpers 60 may be configured to adjoin or abut adjacent bumpers 60 to maintain the desired seal. FIG. 8 illustrates a linear length of wall 10 at which two bumpers 60a, 60b meet. At the junction 80 of the bumpers 60a, 60b, the end of bumper 60a is angled in a first direction while the abutting end of bumper 60b is angled in a the opposite direction. As such, the bumpers 60a and 60b overlap one another and maintain the seal of the gap 13. Referring to FIG. 9, the elastomeric nature of the bumpers 60 may allow adjacent bumpers 60a and 60b to compress relative to one another to form a sealed corner joint 82. Alternatively, the as illustrated in FIGS. 10 and 11, the bumpers 60a and 60b may each have a mitered end to define a mitered joint 84. The various joints are not limited to the illustrated configurations. By having pre-configured joints, installation may be done more quickly and with less labor.

The pre-fabricated fire rated bumper assemblies 50, 50′ provide various advantages. For example, the bumper assemblies 50, 50′ have firestopping built in, without requiring additional firestopping materials to be installed on the job site. The allows the amount of firestopping to be controlled at the factory, providing the right amount each time. Installing the bumper assemblies to the panel prior to placement ensures the void is sealed, without worry that it is overlooked or done improperly in the field. Additionally, there are no jobsite delays due to inclement weather or labor issues and the wall installation does not require coordination of various trades as traditional firestopping assemblies do.

The bumper assemblies 50, 50′ also allow for more movement and tolerate significantly more vertical shear deflection. The compressive nature of the bumpers 60 may allow for less reinforcement for the backpan. Additionally, the bumpers 60 do not have issues with contacting glass. The bumper assemblies 50, 50′ can be used for floor-to-ceiling glass situations such as atriums. Additionally, a solid color, for example, black would look unobtrusive for floor-to-ceiling glass conditions. High rises often have shear walls or large vertical columns that restrict access to the edge the of slab. Custom shapes of the bumper assemblies 50, 50′ can be fabricated to make transitions and directional changes easier such as jogs in the curtain wall or other architectural features that make a building façade distinct.

In addition to providing fire stopping, the bumper assemblies 50, 50′ can also provide water resistance and potential water tightness by integrating a seal at interface with floor and unitized curtain wall. The bumper assemblies 50, 50′ may also provide acoustical benefits by sealing the gap.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as defined in the claims.

1. A curtain wall assembly comprising:
a curtain wall;
a slab attached to the curtain wall with a gap therebetween; and
a fire rated bumper assembly positioned in and sealing the gap between the curtain wall and the slab, the fire rated bumper assembly comprising:
a back plate configured for connection to either the curtain wall or the slab, and
a bumper attached to the back plate, the bumper having an elongated body manufactured from a fire-retardant elastomer and enclosing an insulation material.

2. The assembly of claim 1 wherein the insulation material is a mineral fiber or ceramic fiber blanket.

3. The assembly of claim 1 wherein the insulation material is coiled or folded within the elongated body.

4. The assembly of claim 1 wherein the elongated body has cross-sectional shape selected from semi-circular, square, rectangular and oval.

5. The assembly of claim 1 wherein the back plate defines a pair of opposed flanges configured to receive portions of the elongated body to secure the elongated body to the back plate.

6. The assembly of claim 1 wherein the back plate has a back surface and a pair of flanges extending therefrom which define a channel configured to receive the slab.

7. The assembly of claim 1 wherein the back plate has a planar back surface configured for connection to the curtain wall.

8. The assembly of claim 7 wherein the slab includes an embedded mounting strut and the back plate is configured to be secured to the slab via a mounting plate-bracket secured relative to the embedded mounting strut.

9. The assembly of claim 8 wherein the embedded mounting strut has a C-shaped channel configuration with return flanges along front edges thereof configured to receive and secure fasteners extending through the mounting bracket.

10. The assembly of claim 9 wherein the planar back surface has one or more holes or slots which align with the fasteners extending through the mounting bracket.

11. The assembly of claim 1 wherein adjacent bumpers having angled cut ends to define a mitered joint.

12. A fire rated bumper assembly comprising:
a back plate configured for connection relative to a curtain wall and slab spaced therefrom, and
a bumper attached to the back plate, the bumper having an elongated body manufactured from a fire-retardant elastomer and enclosing an insulation material.

13. The assembly of claim 12 wherein the insulation material is a mineral fiber or ceramic fiber blanket.

14. The assembly of claim 12 wherein the insulation material is coiled or folded within the elongated body.

15. The assembly of claim 12 wherein the elongated body has a cross-sectional shape selected from semi-circular, square, rectangular and oval.

16. The assembly of claim 12 wherein the back plate defines a pair of opposed flanges configured to receive portions of the elongated body to secure the elongated body to the back plate.

17. The assembly of claim 12 wherein the back plate has a back surface and a pair of flanges extending therefrom which define a channel configured to receive the slab.
